(19) United States
(12) Patent Application Publication
(10) Pub. No.: US 2014/0281051 A1
(43) Pub. Date: Sep. 18, 2014

(54) SENSOR TERMINAL CAPABLE OF PERSONALIZING EXTERNAL PHYSICAL DEVICE AND METHOD THEREOF

(71) Applicant: Electronics and Telecommunications Research Institute, Daejeon-si (KR)

(72) Inventors: Byung-Bog LEE, Daejeon-si (KR); Jeong-Gil KO, Daejeon-si (KR); Sang-Gi HONG, Daejeon-si (KR); Nae-Soo KIM, Daejeon-si (KR)

(73) Assignee: Electronics and Telecommunications Research Institute, Daejeon-si (KR)

(21) Appl. No.: 14/062,949

(22) Filed: Oct. 25, 2013

(30) Foreign Application Priority Data
Mar. 14, 2013 (KR) 10-2013-0027575

(51) Int. Cl. G06F 11/30

(52) U.S. Cl. CPC G06F 11/3003
USPC 710/15

(57) ABSTRACT

A sensor terminal capable of personalizing an external physical device. The sensor terminal includes a control unit that recognizes and uses the external physical device as an internal device. The control unit may include a device object driver to manage a device object of one or more physical device and a profile of the device object; and a device service module to generate the device object of the physical device, and register the generated device object and the profile of the device object in the device object driver. Thus, the sensor terminal may recognize and use the external physical device as if it were the internal device.

### CROSS-REFERENCE TO RELATED APPLICATION(S)

This application claims the benefit under 35 U.S.C. §119(a) of Korean Patent Application No. 10-2013-0027575, filed on Mar. 14, 2013, in the Korean Intellectual Property Office, the entire disclosure of which is incorporated herein by reference for all purposes.

### BACKGROUND

1. Field

The following description relates to a sensor terminal, more specifically, the sensor terminal that is capable of communicating with peripheral devices.

2. Description of the Related Art

Sensor terminals equipped with various types of sensors are well known. However, if a plurality of sensor terminals is equipped, separate versions of software for each sensor type become necessary. Also, every time new sensors are added, much time and effort may be expended to develop software that is dependent on an operation function or characteristics of the sensor. As a technology for solving these problems, “Portable terminal apparatus with sensors” has been filed as Korean Patent Registration No. 10-0659228. According to the reference, even in case where new sensors are added and used in a portable terminal apparatus, various sensors may be controlled through a sensor controller, which is sensor-integration software. In addition, even if more sensors are added, it is possible for only a control function of the sensor controller to be changed, which may enable not only minimization of structural change in the existing portable terminal, but also installation and use of various sensors in the terminal apparatus.

However, in order for the sensor terminal to use various sensor functions, it is necessary for all pluralities of sensors to be equipped in the sensor terminal. This means that costs for design and verification of the sensor terminal cannot be avoided when equipping the sensor terminal with newly released various sensors. Also, as the number of sensors newly equipped in the sensor terminal grows, structural changes in design are inevitable. In addition, in terms of size, the increase in the number of sensors may cause undesirable results.

### SUMMARY

The following description aims to provide a sensor terminal and method capable of personalizing an external physical device.

In one general aspect, a sensor terminal capable of personalizing a physical device located externally of the sensor terminal may include a control unit to recognize and use a is physical device located externally of the sensor terminal as an internal device.

The control unit may include a device object driver to manage a device object of one or more physical device and a profile of the device object; and a device service module to generate the device object of the one or more physical device, and register the generated device object and the profile of the device object in the device object driver.

The device service module may detect the one or more physical device and generate the device object of the detected physical device.

The device service module may broadcast a broadcasting message that requests a profile of the physical device, and acquire a profile of the physical device from a unicasting response message received in response to the broadcasting message. The device service module may receive an advertisement message broadcast from the physical device, and acquire a profile of the physical device.

The device service module may remove a device object to be removed and a profile of the device object to be removed from the device object driver.

The device service module may set and control the one or more physical device and a communication path with reference to the profile of the device object managed by the device object driver.

The device service module may enable the device application to access the one or more physical device with reference to data managed by the device object driver.

The device service module may generate the device object with regard to not only the physical device but also the internal device or a virtual device, and register the device object together with a profile of the device object in the device object driver.

The physical device may be a physical sensor or a physical actuator.

In another general embodiment, a method for personalizing a physical device located is externally of a sensor terminal may include detecting a physical device located externally of the sensor terminal; generating a device object of the detected physical device; and registering the generated device object and a profile of the device object.

The detecting of the physical device may include broadcasting a broadcasting message that requests a profile of the physical device, and acquiring the profile of the physical device from a unicasting response message received in response to the broadcasting message.

The detecting of the physical device may include receiving a broadcasting advertisement message from the physical device and acquiring a profile of the physical device.

The method may further include setting and controlling the physical device and a communication path with reference to the profile of the device object selected among the registered device objects.

Other features and aspects may be apparent from the following detailed description, the drawings, and the claims.

### BRIEF DESCRIPTION OF THE DRAWINGS

FIG. 1 is a diagram illustrating an example of a sensor terminal.

FIG. 2 is a diagram illustrating an example for describing procedures for detecting sensors.

FIG. 3 is a diagram illustrating an example of a system for generating a sensor object and managing its information.

FIG. 4 is a diagram illustrating an example of sensor object descriptor data, which is is stored and managed in a sensor object repository.

FIG. 5 is a diagram illustrating an example of a sensor routing information table.

FIG. 6 is a flowchart illustrating a method of detecting and registering a physical sensor.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. In description below, embodiments may be limited to a term ‘sensor’; however, it may be broadly interpreted as not a sensing means but also another means ‘device’ such as an actuator.

First and foremost, the following, are definitions to help clarify the embodiments.
Physical Sensor: an element or device for quantitatively measuring physical phenomena of a surrounding environment, and detecting information, equipped in a sensor field,
Logical Sensor: a physical sensor stored/managed in a form of data in computer space.
Virtual Sensor: a sensor that is a software-defined sensor, which does not exist in physical space, and made in combination with logical sensors.
Sensor Object Repository: memory space of a computer in which sensor objects are is stored.
Sensor: an element or device which quantitatively measures physical phenomena of a surrounding environment and detects information.
Sensor Node: a device used to attach sensors (e.g., an illuminance sensor and a temperature sensor, etc.), which quantitatively measure physical phenomena of a surrounding environment, and exchange sensing information with neighboring nodes with a communication module.
Application: an application that runs in the sensor terminal, or an entity which interacts with sensor objects.
PUSH service supporting sensor: a sensor that unilaterally notifies sensing data.
PULL service supporting sensor: a sensor that responds with sensing results in response to sensing data requests.

FIG. 1 is a diagram illustrating an example of a sensor terminal.

A sensor terminal may be implemented in combination with hardware and software composition. Although not illustrated in figures, the sensor terminal may include a composition of hardware, such as a control unit including memory, and a communication unit, etc. The composition of software capable of being implemented in the control unit may include a sensor application 100, a sensor service module 200, a sensor object driver 300, and a sensor network interface 400 as illustrated in FIG. 1. The sensor service module 200 includes a physical sensor handler 210 and a sensor object handler 220. The physical sensor handler 210 includes a physical sensor detecting module 211 and a physical sensor control module 212. The sensor object handler 220 includes a sensor object registration/deregistration module 221 and a sensor object control module 222. The sensor object driver 300 includes a sensor object repository 310 and a sensor object context manager 320.

The sensor application 100 accesses the sensor object or physical sensor through the sensor service module 210 or sensor object handler 220, respectively, which are elements of the sensor service module 200. The physical sensor handler 210 activates the physical sensor detecting module 211, and detects the physical sensor outside of the sensor terminal. Here, the physical sensor equipped in the sensor terminal also may be detected. If the physical sensor is detected by the physical sensor detecting module 211, the physical sensor handler 210 receives a profile of the detected physical sensor, and generates a sensor object, which interacts (i.e., binding or fairing) with the physical sensor through the sensor object registration/deregistration module 221, in the sensor object repository 310. And the physical sensor handler 210 provides the sensor object context manager 320 with information (profile data) about a sensor object, and manages it in the sensor terminal. The physical sensor control module 212 in the physical sensor handler 210 selects which sensor object to control, and then referring to sensor profile data (a sensor network interface, a communication channel, a sensor identifier, etc.), sets which physical sensor and communication path to control, and controls the physical sensor.

A sensor object registration/deregistration module 221 in the sensor object handler 220 may support a function of registering or deregistering the sensor object of the physical sensor. Also, the sensor object control module 222 may support a sensor object control function to search and access the sensor object. A registration function of the sensor object registration/deregistration module 221 generates the sensor object about the physical sensor, which is detected by the physical sensor detecting module 211, in the sensor object repository 310. Then, the registration function provides information about the generated sensor object to the sensor object context manager 320, and ensures that the sensor terminal manages it. When the physical sensor is no longer used, or becomes difficult to be accessed because of is environmental causes, a deregistration function of the sensor object registration/deregistration module 221 removes the sensor object stored in the sensor object repository 310, and informs the sensor object context manager 320 about the removal, and deletes the sensor object registration information from the sensor terminal.

A sensor network interface 400 may support an interconnection with sensor nodes that support a network interface, such as Wi-Fi®, IEEE 802.15.4-based, Bluetooth®, and the like.

FIG. 2 is a diagram illustrating an example for describing procedures of detecting a sensor.

The sensor terminal activates a physical sensor detecting module 211, and broadcasts a broadcasting message to request a physical sensor profile to sensor nodes, which are installed in their surroundings in accordance with an address system of sensor network. If supporting a multi-network interface and communication channel, the sensor terminal broadcasts a broadcasting message while at the same time changing the multi-network interface and communication channel. After the broadcasting, the sensor terminal receives a unicasting response message including the profile of the physical sensor located within range of the broadcasting message. The sensor terminal may receive a profile of the physical sensor located more than one hop distance away from the sensor terminal via relay of the sensor node that is within one hop distance. If the physical sensor profile is acquired, the sensor terminal generates a sensor object in a sensor object repository 310, and provides the sensor object information to a sensor object context manager.

In another example, the sensor terminal may receive a sensor advertisement message broadcast by the sensor nodes installed in the surroundings, and acquire the profile of the is physical sensor from the advertisement message. When supporting the multi-network interface and communication channel, the sensor terminal broadcasts a sensor advertisement message that the sensor node broadcasts, while at the same time changing the multi-network interface and communication channel. The sensor terminal receives, through multi-hop relay, the physical sensor profile message that the sensor node located beyond a one hop distance notifies in a form of a broadcasting message. If the sensor profile is acquired, the sensor terminal generates a sensor object in a sensor object repository 310, and provides the sensor object information to a sensor object context manager.

Before or after a process of searching and connecting the surrounding sensor nodes and acquiring the physical sensor profile, while at the same time changing the communication channel, the sensor terminal may apply an additional communication channel unification signal system between the sensor terminal and sensor node so as to unify the sensor nodes, which use an identical sensor network interface, but have different communication channels, into a unified communication channel. This is to avoid a multi-channel management complexity.

FIG. 3 is a diagram illustrating an example of a system for generating a sensor object and managing its information.

If a sensor object is generated in a sensor object repository 310 by a sensor object registration function, the sensor object is updated in ‘red-black-tree’ and ‘sensor-ref’, and a ‘sensor_type_list’ is updated by a sensor object context manager 320 that has received sensor object generation information. The ‘sensor_type_list’ is used as reference information to search for sensor-related information that is to be referred in a sensor application 100. In addition, a ‘sensor_object_descriptor’ has only a value in ‘red-black-tree’, and the sensor object is identified by a ‘sensor_object_identifier.’

FIG. 4 is a diagram illustrating an example of sensor object descriptor data, which is stored and managed in a sensor object repository.

A sensor object maintains and manages a sensor object identifier; a sensor-related address system and communication information; sensor descriptor data; and sensor status and sensing value. A sensor network interface identifier specifies a communication interface (WiFi, IEEE 802.15.4-based, Bluetooth, etc.) of a sensor node in which a physical sensor is equipped. A communication channel identifier is set autonomously by a sensor network or manually by its manager. A ‘pan identifier or ssid’ is set autonomously by the sensor network or manually by its designer. The sensor node identifier is an identifier that only identifies a sensor node in the sensor network in which the sensor node is included, dynamically allocated by a PAN coordinator or fixedly allocated on the sensor node by a sensor node developer or its manager. The sensor descriptor data includes a sensor type, a sensor unit (that is, a sensing value descriptor unit), a minimum/maximum sensing value, sensing value accuracy, and a service type that sensor supports. After the physical sensor status is checked, if the sensor is in an orphaned state, the sensor status is used to autonomously remove the sensor from the sensor terminal or notify the sensor application, and help a user to determine deregistration.

FIG. 5 is a diagram illustrating an example of a sensor routing information table.

FIG. 5 shows examples of the sensor object registered in the sensor object repository and the sensor routing information table to access the bound (fairing) physical sensor in a case where surrounding sensor nodes, where an identical address system value is allocated, are connected to the sensor terminal with each different number of hops in a plurality of sensor networks installed in a visited location. In FIG. 2, if SN2 in a sensor network B and SN2 in a sensor network C is have identical address values, both SN2, each of which exists in the sensor network B and sensor network C, and a routing information table for accessing SN2 are required. To access S1 of SN2 in the sensor network B, a routing record including a destination sensor node identifier, a next sensor node identifier, and a sensor object descriptor, consisting, respectively, of SN2, SN1, and a sensor object descriptor value that is allocated when the sensor object is registered, is added to the routing information table. In addition, to access S1 of SN2 in the sensor network C, a routing record including a destination sensor node identifier, a next sensor node identifier, and a sensor object descriptor, consisting, respectively, of SN2, SN2, and a sensor object descriptor value that is allocated when the sensor object is registered, is added to the routing information table.

FIG. 6 is a flowchart illustrating a method of detecting and registering a physical sensor.

A sensor terminal may select a sensor network interface, and set a communication channel in S100. Then, the sensor terminal may broadcast a broadcasting message requesting a physical sensor profile to sensor nodes installed in its surroundings, and receive a unicasting response message including the physical sensor profile from the sensor node located within range of the broadcasting message in S200. In the case where support is provided to a multi-network interface and communication channel, the sensor terminal broadcasts a broadcasting message while at the same time changing multi-network interface and channel. In another example, the sensor terminal may receive the sensor advertisement message that the sensor node broadcasts, and acquire the physical sensor profile from that sensor advertisement message in S300. At that time as well, where support is provided to a multi-network interface and communication channel, the sensor terminal may receive the sensor advertisement message while at the same time changing the multi-network interface and communication channel. The is sensor terminal may make a sensor profile list for all the detected physical sensors in S400, generate a sensor object of a detected sensor in a sensor object repository 310 in S500, and register the generated sensor object information in the sensor object context manager 320 in S600. Afterwards, as mentioned above, the sensor terminal may set and control a physical device and a communication path with reference to the selected sensor object profile among the registered sensor objects.

As such, the above-mentioned process of detecting and registering the physical sensor may be applied not only to the physical sensor installed in the sensor node, which exists outside the sensor terminal, but also to both a sensor installed inside the sensor terminal and a physical sensor installed in a sensor terminal port (e.g., USB/UART port).

In conclusion, the sensor terminal receives its profile from the external sensor node in physical space through the sensor network interface, generates the sensor object, which is interconnected to the physical sensor in a sensor terminal memory space, and manages the generated sensor object information. All of these operations enable a sensor application to access the physical sensor with reference to data that the sensor object manages. So, by those operations, the sensor application can use a group of sensors, which are located outside the sensor terminal, as internal sensors of the sensor terminal.

The above-mentioned personalization concept of a physical sensor can be adapted to a physical actuator, a software-defined virtual sensor, and a virtual actuator, in addition to the physical sensor. Also, the sensor terminal may generate and manage the sensor object of the unified formal format with regard to the physical sensor, the physical actuator, the software-defined virtual sensor, and the virtual actuator.

In an embodiment, the sensor terminal equipped with a limited number of sensors provides a indivisual-centered sensor usage technology capable of being personalized and freely is used as either the physical sensor to which the sensor terminal is connected through the external USB/UART installed in the surroundings or the physical sensor installed in the external sensor node, which is installed in the sensor terminal. This technology may contribute to the creation and activation of various Ubiquitous Sensor Network (USN) services through the use of sensors that exist in everyday life.

In addition, because the physical sensor personalization concept can also be applied to the physical actuator, the software-defined virtual sensor, and the virtual actuator, the physical sensor personalization can also contribute to the creation and activation of the sensor and actuator application service that controls the sensor and the actuator.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable is codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A sensor terminal capable of personalizing a physical device located externally of the sensor terminal, the sensor terminal comprising:
a control unit configured to recognize and use a physical device located externally of the sensor terminal, as an internal device.

2. The sensor terminal of claim 1, wherein the control unit comprises:
a device object driver configured to manage a device object of one or more physical device and a profile of the device object; and
a device service module configured to generate the device object of the one or more physical device, and register the generated device object and the profile of the device object in the device object driver.

3. The sensor terminal of claim 2, wherein the device service module detects the one or more physical device and generates the device object of the detected physical device.

4. The sensor terminal of claim 3, wherein the device service module broadcasts a broadcasting message that requests a profile of the physical device, and acquires a profile of the physical device from a unicasting response message received in response to the broadcasting message.

5. The sensor terminal of claim 3, wherein the device service module receives an advertisement message broadcast from the physical device, and acquires a profile of the physical device.

6. The sensor terminal of claim 2, wherein the device service module removes a device object to be removed and a profile of the device object to be removed from the device object driver.

7. The sensor terminal of claim 2, wherein the device service module sets and controls the one or more physical device and a communication path with reference to the profile of the device object managed by the device object driver.

8. The sensor terminal of claim 7, wherein the device service module enables the device application to access the one or more physical device with reference to data managed by is the device object driver.

9. The sensor terminal of claim 2, wherein the device service module generates the device object with regard to not only the physical device but also the internal device or a virtual device, and registers the device object together with a profile of the device object in the device object driver.

10. The sensor terminal of claim 1, wherein the physical device is a physical sensor or a physical actuator.

11. A method for personalizing a physical device located externally of a sensor terminal, the method comprising:
detecting a physical device located externally of the sensor terminal;
generating a device object of the detected physical device; and
registering the generated device object and a profile of the device object.

12. The method of claim 11, wherein the detecting of the physical device comprises broadcasting a broadcasting message that requests a profile of the physical device, and acquiring the profile of the physical device from a unicasting response message received in response to the broadcasting message.

13. The method of claim 11, wherein the detecting of the physical device comprises receiving a broadcasting advertisement message from the physical device and acquiring a profile of the physical device.

14. The method of claim 11, further comprising:
setting and controlling the physical device and a communication path with reference to the profile of the device object selected among the registered device objects.
